(19) United States
(12) Patent Application Publication
(10) Pub. No.: US 2013/0080687 A1
(43) Pub. Date: Mar. 28, 2013

(54) SOLID STATE DISK EMPLOYING FLASH AND MAGNETIC RANDOM ACCESS MEMORY (MRAM)

(71) Applicants: Siamack Nemazie, Los Altos Hills, CA (US); NGON VAN LE, Fremont, CA (US)

(72) Inventors: Siamack Nemazie, Los Altos Hills, CA (US); NGON VAN LE, Fremont, CA (US)

(73) Assignee: AVALANCHE TECHNOLOGY, INC., Fremont, CA (US)

(21) Appl. No.: 13/570,202

(22) Filed: Aug. 8, 2012

Related U.S. Application Data
(60) Provisional application No. 61/538,697, filed on Sep. 23, 2011.

(51) Int. Cl. G06F 12/02

(52) U.S. Cl. 711/103; 711/E12.008

(57) ABSTRACT

A central processing unit (CPU) subsystem is disclosed to include a MRAM used among other things for storing tables used for flash block management. In one embodiment all flash management tables are in MRAM and in an alternate embodiment tables are maintained in DRAM and are near periodically saved in flash and the parts of the tables that are updated since last save are additionally maintained in MRAM.

### CROSS REFERENCE TO RELATED APPLICATIONS

This application claims priority to U.S. Provisional Application No. 61/538,697, filed on Sep. 23, 2011, entitled “Solid State Disk Employing Flash and MRAM”, by Siamack Nemazie.

### BACKGROUND OF THE INVENTION

1. Field of the Invention

The invention relates to a solid state storage device including magnetic random access memory (MRAM) and particularly to file management within the solid state storage device.

2. Description of the Prior Art

Solid State Drives (SSDs) using flash memory have become a viable alternative to Hard Disc Drives in many applications. Such applications include storage for notebook and tablets were storage capacity is not too high and power, and or weight and form factor are key metrics and storage for servers were both power and performance (sustained read/write, random read/write) are key metrics.

Flash memory is a block based non-volatile memory with each block is organized into and made of various pages. After a block is programmed it must be erased prior to programming it again, most flash memory require sequential programming of pages within a block. Another limitation of flash memory is that blocks can be erased for a limited number of times, thus frequent erase operations reduce the life time of the flash memory. A Flash memory does not allow in-place updates. That is it cannot overwrite new data into existing data. The new data are written to erased areas (out-of-place updates), and the old data are invalidated for reclamation in the future. This out-of-place update causes the coexistence of invalid (i.e. outdated) and valid data in the same block. Garbage Collection is the process to reclaim the space occupied by the invalid data, by moving valid data to a new block and erasing the old block. Garbage collection results in significant performance overhead as well as unpredictable operational latency. As mentioned flash memory blocks can be erased for a limited number of times. Wear leveling is the process to improve flash memory life time by evenly distributing erases over the entire flash memory (within a band).

The management of blocks within flash based memory system including SSDs is referred to as flash block management and includes: Logical to Physical Mapping, Defect management for managing defective blocks (blocks that were identified to be defective at manufacturing and grown defective blocks thereafter), wear leveling to keep program/erase cycle of blocks within a band, keeping track of free available blocks, garbage collection for collecting valid pages from a plurality of blocks (with a mix of valid and invalid page) into one block and in the process creating free blocks.

The flash block management requires maintaining various tables. These tables reside on flash and all or portion of the tables can be additionally cached in a volatile memory (DRAM or CPU RAM).

In a SSD that has no battery or dynamically charged super capacitor back-up circuitry, the flash block management tables that resides in the flash memory may not be updated and/or may be corrupted if power failure occurs during the time a table is being saved (or updated) in the flash memory. Hence, during a subsequent power up, during initialization the tables have to be inspected for corruption due to power fail and if necessary recovered. The recovery requires reconstruction of the tables to be completed by reading metadata from flash pages and further increasing latencies. The process of completely reconstruction of all tables is time consuming, as it requires metadata on all pages of SSD to be read and processed to reconstruct the tables. Metadata is non-user information written in the extension area of a page. This flash block management table recovery during power up will delay the SSD being ready to respond to commands from the host which is key metric in many applications.

This increases the time required to power up the system until the system is ready to accept a command. In some prior art techniques, a battery-backed volatile memory is utilized to maintain the contents of volatile memory for an extended period of time until power is back and tables can be saved in flash memory.

Battery backup solutions for saving system management data or cached user data during unplanned shutdowns are long-established but have certain disadvantages including up-front costs, replacement costs, service calls, disposal costs, system space limitations, reliability and “green” content requirements.

Yet another similar problem of data corruption and power fail recovery arises in SSDs and also HDDs when write data for write commands (or queued write commands when command queuing is supported) is cached in a volatile memory (such as a DRAM) and command completion issued prior to writing to media (flash or Hard Disc Drive). It is well known in the art that caching write data for write commands (or queued write commands when command queuing is supported) and issuing command completion prior to writing to media significantly improves performance.

As previously mentioned battery backup solutions for saving cached data during unplanned shutdowns are long-established and proven, but have disadvantages as mentioned previously.

What is needed is a method and apparatus using magnetic random access memory (MRAM) to reliably and efficiently preserve data in the memory of a solid state disk system or hard disc drive (HDD) even in the event of a power interruption.

### SUMMARY OF THE INVENTION

Briefly, in accordance with a one system of the invention, a CPU subsystem includes an MRAM used among other things for storing tables used for flash block management. In one embodiment all flash management tables are in MRAM and in an alternate embodiment tables are maintained in DRAM and are near periodically saved in flash and the parts of the tables that are updated since last save are additionally maintained in MRAM.

Briefly, in accordance with a yet another embodiment of the present invention, a solid state storage device (SSD) is configured to store information from a host, in blocks, the SSD includes a buffer subsystem that has a dynamic random access memory (DRAM). The DRAM includes block management tables that maintain information used to manage blocks in solid state storage device and includes tables to map logical to physical blocks for identifying the location of stored data in the SSD, the DRAM is used to save versions of at least some of the block management tables. Further, the SSD has a flash subsystem that includes flash memory, the flash memory is configured to save a previous version of the block management table and a current version of the block management table

Additionally, the SSD has a central processing unit subsystem including magnetic random access memory (MRAM), the MRAM is configured to store changes to the block management table in the DRAM, wherein the current version of the block management table in flash along with the updates saved in MRAM is used to reconstruct the block management table of the DRAM upon up of the solid state storage device.

These and other objects and advantages of the invention will no doubt become apparent to those skilled in the art after having read the following detailed description of the various embodiments illustrated in the several figures of the drawing.

### IN THE DRAWINGS

FIG. 1 shows a solid state storage device 10, in accordance with an embodiment of the invention.

FIG. 1a shows further details of the buffer subsystem of the device 10 of FIG. 1.

FIG. 2a shows further details of the CPU subsystem 170, in accordance with another embodiment of the invention.

FIG. 2b shows a CPU subsystem 171, in accordance with another embodiment of the invention.

FIG. 2c shows a CPU subsystem 173, in accordance with yet another embodiment of the invention.

FIG. 3a shows a flash management table 201, in accordance with an embodiment of the invention.

FIG. 3b shows further details of the table 212.

FIG. 3c shows further details of the table 220.

FIG. 4 shows exemplary data structures stored in each of the MRAM 140, DRAM 62, and flash 110.

FIG. 5 shows a process flow of the relevant steps performed in allocating tables using the embodiments shown and discussed relative to other embodiments herein and in accordance with a method of the invention.

FIGS. 6a-6c show exemplary data structures in the MRAM 140, in accordance with embodiments of the invention.

FIG. 7 shows a process flow 510 of the relevant steps performed when writing data to the tables of the flash 110, in accordance with a method of the invention.

FIG. 8 shows a SSD 600 in accordance with another embodiment of the invention.

### DETAILED DESCRIPTION OF THE VARIOUS EMBODIMENTS

In the following description of the embodiments, reference is made to the accompanying drawings that form a part hereof, and in which is shown by way of illustration of the specific embodiments in which the invention may be practiced. It is to be understood that other embodiments may be utilized because structural changes may be made without departing from the scope of the present invention. It should be noted that the figures discussed herein are not drawn to scale and thicknesses of lines are not indicative of actual sizes.

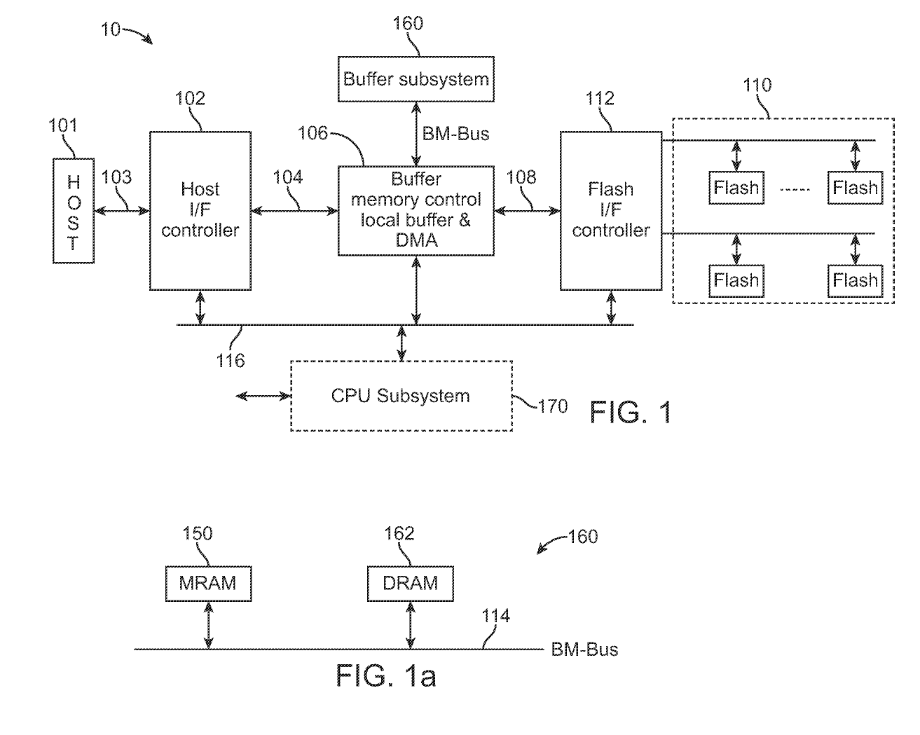

Referring now to FIG. 1, a solid state storage device 10 is shown to include a host 101, a host interface controller 102, a buffer memory control block 106, a flash interface controller 112, a flash subsystem 110, a buffer subsystem 160, and a central processor unit (CPU) subsystem 170, in accordance with an embodiment of the invention.

The host 101 is shown to be coupled to the host interface controller 102 through the host bus 103 and the host interface controller 102 is shown coupled to the buffer memory control block 106 through the host controller bus 104 and the buffer memory block 106 is shown coupled to the flash interface controller 112 through the flash controller bus 108 and the buffer subsystem 160 is shown coupled to the buffer memory block 106 and the host interface controller 102, the buffer memory control block 106 and the flash interface controller 112 are each shown coupled to the CPU subsystem 170 through the CPU bus 116. The flash interface controller 112 is shown coupled to the flash subsystem 110.

The host 101 sends and receives command/status and data. The host interface controller 102 manages the host interface protocol, the buffer memory control 106 transfers data between the memory subsystem 160 and the host I/F, Flash I/F and the CPU subsystem. The buffer subsystem 160 stores user and system management information. The flash interface controller 112 interfaces with flash subsystem. The flash 110 is used as persistent storage for storage of data. The CPU subsystem 170 controls and manages and execution of host commands.

The flash subsystem 110 is shown to include a number of flash memory components or devices, which can be formed on a single semiconductor or die or on a number of such devices.

The buffer subsystem 160 can take on various configurations. In some configurations, it includes DRAM and in others, it includes DRAM and MRAM, such as that which is shown in FIG. 1a.

FIG. 1a shows further details of the buffer subsystem of the device 10 of FIG. 1. In the embodiment of FIG. 1a, the buffer subsystem 160 is shown to include a DRAM 162 and a MRAM 150, both of which are coupled to block 106 via a single interface bus, the BM-Bus 114. In other embodiments, this bus is made of two busses, one for the DRAM 162 and the other for the MRAM 150. The CPU subsystem 170 can access the buffer system 160 concurrently with other accesses. CPU accesses to buffer subsystem 160 are interleaved with host I/F and flash I/F accesses to the buffer subsystem 160. In this embodiment the CPU subsystem 170 may or may not include MRAM. In yet another embodiment, all the flash management tables are maintained in the MRAM 150 that is directly coupled to the BM-Bus 114. In yet another embodiment, the flash management tables are cached in DRAM 162 but the update in between saves to the flash 110 are maintained in the MRAM 150 that resides on the BM-Bus 114. In yet another embodiment, the updates in between saves to the flash 110 are maintained in the MRAM 140.

In some embodiments, the MRAM 150 is made of spin transfer torque MRAM (STTMRAM) cells and in other embodiments, it is made of other magnetic memory cells.

Further, a write cache function is anticipated. With a write cache, the system sends completion status of a write command after all the write data is received from the host and before all written to the media. The problem with write cache is power fail prior to writing data in cache to the media, requiring battery-backed or capacitor power-backed RAM. In accordance with various methods and embodiments of the invention, the write data is saved in the MRAM along with state information to indicate that the data has been written to media. On power up, during initialization the write cache state information is read and any pending write in the write cache which was not completed due to a power fail will be completed.

Command Queuing protocols such as Serial ATA Attachment (hereinafter “SATA”) allow host to send a number of commands (in case of SATA, 32 commands) while the completion status of some of the commands are pending as long as the number of outstanding commands with pending completion status does not exceed a threshold agreed by host and device.

Write Cache in conjunction with command queuing effectively increases the number of write commands the device can process beyond the threshold agreed upon by host and device.

The CPU subsystem 170 can take on various configurations. In some configurations, it includes SRAM and ROM and in others, it additionally includes MRAM.

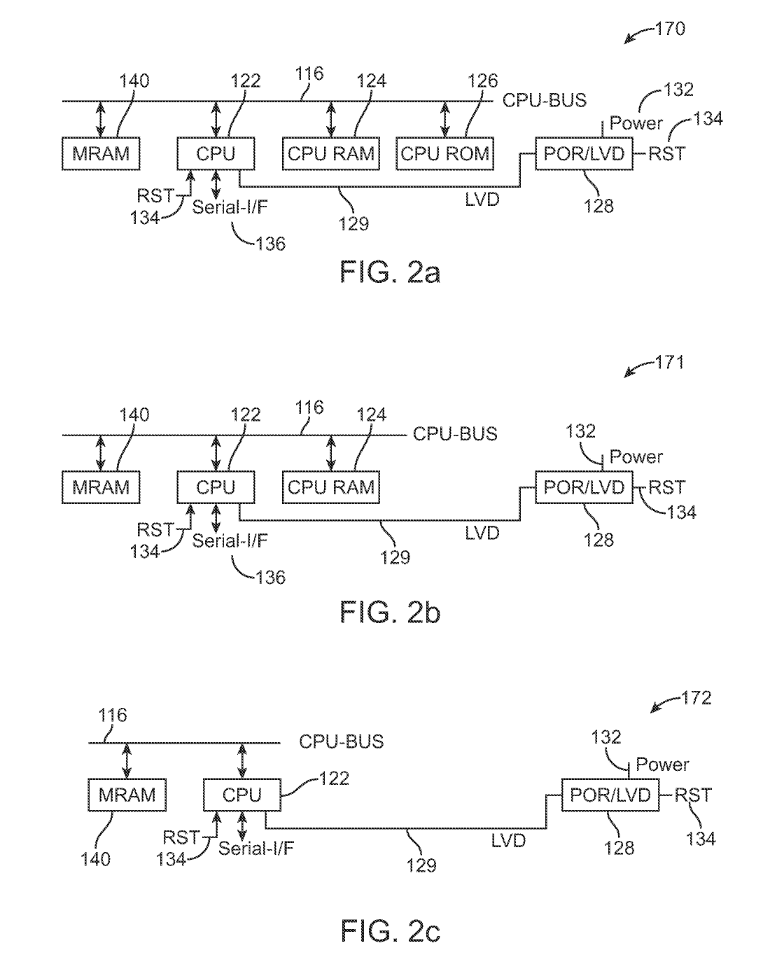

FIG. 2a shows further details of the CPU subsystem 170, in accordance with another embodiment of the invention. The CPU subsystem 170 is shown to include a magnetic random access memory (MRAM) 140, a CPU 122, a CPU random access memory (RAM) 124, a CPU read-only-memory (ROM) 126, and a power-on-rest/low-voltage-detect (POR/LVD) block 128. Each of the MRAM 140, CPU 122, CPU RAM 124, and CPU ROM 126 is shown coupled to the bus 116. The block 128 is shown to generate a low voltage detect signal 129, coupled to the CPU 122. The block 128 is shown to generate a reset signal, RST 134, for resetting the system 10. The block 128 is also shown to receive a power signal 132. The CPU 122 also receives the RST 134 as well as receiving and sending information through a serial interface 136 communicates with external devices via a serial interface.

As in the case of MRAM 150, the MRAM 140 may be made of STTMRAM cells or other magnetic memory cells.

The CPU 122 is well know in the art and the MRAM 140, the CPU RAM 124 and CPU ROM 126 each serve as memory in various capacities, as discussed below. The MRAM 140, CPU 122, CPU RAM 124, and CPU ROM 126 are each shown coupled to the bus 116.

FIG. 2b shows a CPU subsystem 171, in accordance with another embodiment of the invention. In FIG. 2b, the subsystem 171 is analogous to the subsystem 170 but with a different configuration. The CPU ROM 126 of the subsystem 170 is absent in the subsystem 171. The MRAM 140 additionally performs the function of ROM (read only Memory) a portion of MRAM is used as a ROM which can be initialized via CPU 124 and serial interface 136 at manufacturing phase or in the field.

The low voltage detect (LVD) signal 129 indicates a low voltage has been detected and is an input to the CPU 122. Generally, minimal house cleaning is performed by the CPU 122 prior to times when the CPU halts. In particular, there will not be enough time to complete large DMA transfers of data or tables to DRAM and or the flash memory prior to the time the CPU halts.

In the embodiments of FIGS. 2a, 2b, and 2c, information is kept on a non-volatile MRAM 140 to minimize the time to reconstruct tables on subsequent power up. Different information sets can be kept on the MRAM to minimize flash block management table recovery time during power up. An aspect is keeping the information in a non-volatile MRAM where writing to a table entry in MRAM is initiated at or prior to LVD assertion can be completed during house cleaning time between LVD assertion and the CPU stopping/halting.

FIG. 2c shows a CPU subsystem 173, in accordance with yet another embodiment of the invention. The CPU subsystem 173 is analogous to those of the FIGS. 2a and 2b except that the subsystem 173 is absent the CPU ROM 126 and the CPU RAM 124. The MRAM 140 additionally performs the function of ROM (read only Memory) as mentioned before and SRAM thus eliminating both parts. As previously indicated, the CPU subsystem 170 can take on various configurations, with and without MRAM 140.

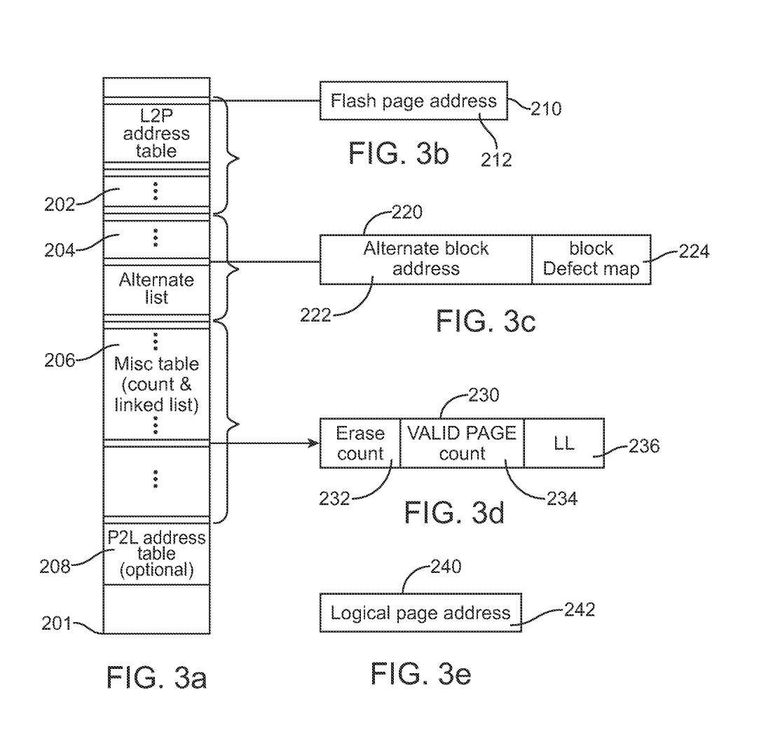

FIG. 3a shows a flash management table 201, in accordance with an embodiment of the invention. In one embodiment the table 201 is saved in the MRAM 140 and in another embodiment in MRAM 150 Further, as shown in FIG. 3a, it typically includes various tables. For example, the table 201 is shown to include a logical address-to-physical address table 202, a defective block alternate table 204, a miscellaneous table 206, and an optional physical address-to-logical address table 208.

In one embodiment the flash management table 201 and all of its tables are stored in the MRAM 140 of the CPU subsystem 170 of FIG. 1. A summary of the tables within the table 201 is as follows:
Logical Address to Physical (L2P) Address Table 202
Defective Block Alternate Table 204
Miscellaneous Table 206
Physical Address to Logical (P2L) Address Table (Optional) 208

The table 202 (also referred to as “L2P”) maintains the physical page address in flash corresponding to the logical page address. The logical page address is the index in the table and the corresponding entry 210 includes the flash page address 212.

The table 220 (also referred to as “Alternate”) keeps an entry 220 for each predefined group of blocks in the flash. The entry 220 includes a flag field 224 indicating the defective blocks of a predefined group of blocks, the alternate block address field 222 is the address for substitute group block if any of the blocks is defective. The flag field 224 of the alternate table entry 220 for a grouped block has a flag for each block in the grouped block, and the alternate address 222 is the address of substitute grouped block. The substitute for a defective block in a grouped block is the corresponding block (with like position) in the alternate grouped block.

The table 206 (also referred to as “Misc”) keeps an entry 230 for each block for miscellaneous flash management functions. The entry 230 includes fields for block erase count (also referred to as “EC”) 232, count of valid pages in the block (also referred to as “VPC”) 234, various linked list pointers (also referred to as “LL”) 236. The EC 232 is a value representing the number of times the block is erased. The VPC 234 is a value representing the number of valid pages in the block. Linked Lists are used to link a plurality of blocks for example a Linked List of Free Blocks. A Linked List includes a head pointer; pointing to first block in the list, and a tail pointer pointing to the last element in the list. The LL 236 field points to the next element in the list. For a double linked list the LL field 236 has a next pointer and a previous pointer. The same LL field 236 may be used for mutually exclusive lists, for example the Free Block Linked List and the Garbage Collection Linked List are mutually exclusive (blocks can not belong to both lists) and can use same LL field 236. Although only one LL field 236 is shown for Misc entry 230 in FIG. 3d, the invention includes embodiments using a plurality of Linked List fields in the entry 230.

The physical address-to-logical address (also referred to as “P2L”) table 208 is optional and maintains the logical page address corresponding to a physical page address in flash; the inverse of L2P table. The physical page address is the index in the table 208 and the corresponding entry 240 includes the logical page address field 242.

The size of some of the tables is proportional to the capacity of flash. For example the L2P table 202 size is (number of pages) times (L2P table entry 210 size), and number of pages is capacity divided by page size, as a result the L2P table 202 size is proportional to capacity of flash 110.

Another embodiment that uses a limited amount of MRAM 140 (i.e. not scaled with capacity of flash 110) will be presented next. In this embodiment the tables are maintained in flash 110 and cached in DRAM 162, and copied to DRAM 162 during initialization after power up. Subsequently any update to tables is written to the copy in DRAM. The tables are completely cached in DRAM 162. The tables cached in DRAM 162 are periodically and/or based on some events (such as a Sleep Command) saved (copied) back to flash 110. The updates to tables in between copy back to flash are additionally written to the MRAM 140, or alternatively the MRAM 150, and identified with a revision number. The updates associated with last two revisions number are maintained and updates with other revision number are not maintained. When performing table save concurrent with host commands, to minimize impact on performance, the table save operation is interleaved with the user operations at some rate to guarantee completion prior to next cycle.

FIG. 3b shows further details of the entry 212 of table 202. FIG. 3c shows further details of the entry 220 of table 204. The entry 220 is shown to include the fields 222 and 224. FIG. 3d shows further details of the entry 230 of table 206. The entry 230 is shown to include the fields 232, 234, and 236. FIG. 3e shows further details of the entry 240 of table 208 including field 242.

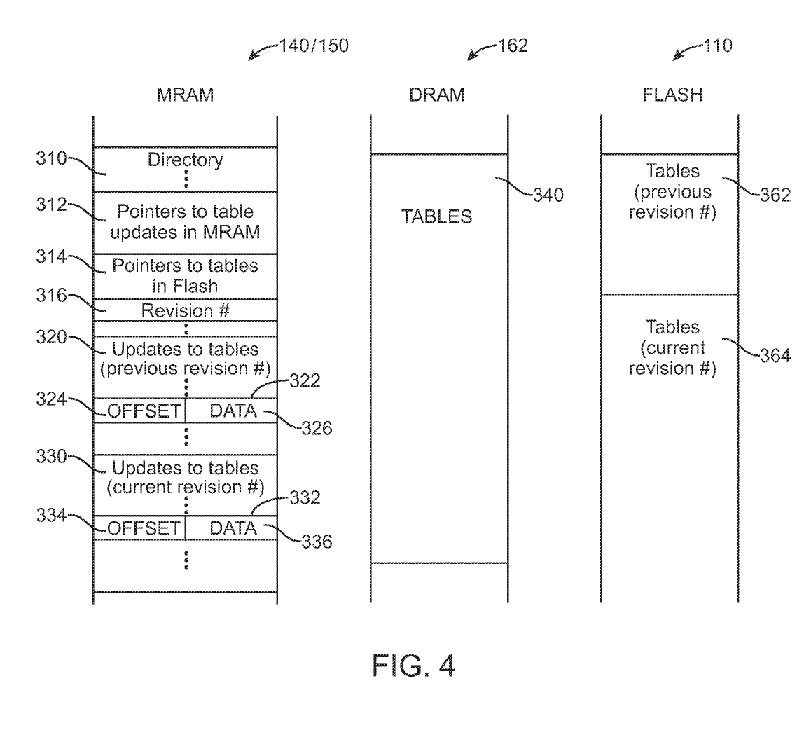

FIG. 4 shows exemplary data structures stored in each of the MRAM 140/150, DRAM 162, and flash 110 of the embodiments of prior figures. The DRAM 162 is in the buffer subsystem 160 of FIG. 1. The data structures in the DRAM 162 include flash management tables 340. The data structure in flash 110 includes a previous copy 362 and a current copy 364 of the tables 340 in the DRAM 162, copies 362 and 364 are identified with a revision number and further include the current revision number and the previous copy of the tables 340 with the previous revision number of the table. The revisions 362 and 364 are snapshots and updates to table 340 since these snapshot are saved in flash would be missing and saved in MRAM. The data structures in the MRAM 140 include the directory 310, updates 330 to the tables that are the current revision's snapshot, referred to and shown in FIG. 4 as the updates 320 and the previous revision's snapshot, referred to and shown in FIG. 4 as the pointers 312. The pointers 314 identify or point to the tables in the flash subsystem 110. The revision number 316, entry 322 of the updates 320, and the entry 332 which are entries of the updates 330 are also saved in the MRAM 140. The pointers 312 is a table of pointers pointing to addresses in the MRAM 140 where updates to the tables 340 are located. The pointers 314 is a table of pointers to locations in the flash 110 where the tables 362 and 364 are located. The directory 310 includes pointers to the data structures.

Each of the entries 322 and 332 comprises two parts, an offset field and a data field. The entry 322 includes an offset field 324 and a data field 326 and the entry 332 includes an offset field 334 and a data field 336. In each case, the offset field and the data field respectively identify a location and data used to update the location.

For example, the offset field 324 indicates the offset from a location starting from the beginning of a table that is updated and the data field 326 indicates the new value to be used to update the identified location within the table.

The offset field 334 indicates the offset of a location from beginning of a table that is to be updated and the data field 326 indicates the new value used to update the identified location.

Accordingly, the device 10 of FIG. 1 is configured to store information from the host 101, in blocks and the buffer subsystem 160 includes the DRAM 162, which includes block management tables used for flash block management, such as the tables of the MRAM 140, the DRAM 162, and the flash 110 of FIG. 4. These tables maintain information used for flash block management in the device 10, including tables used to map logical to physical blocks for identifying the location of stored data in the SSD, the DRAM 162 saves latest versions of at least some of the block management tables. A flash subsystem includes the flash 110 that is configured to save snapshots of block management tables including a previous version of the block management table and a current version of the block management tables. Updates from the time the snapshots are taken are saved in MRAM 150 or 140 depending on the embodiment used. Further, the current version of the block management table along with updates in MRAM are used to reconstruct the block management table of the DRAM 162 upon power interruption to the solid state storage device.

The table 330 within the MRAM (140 or 150) is configured to store the changes in the current version of the block management table and the table 320 of the MRAM 140 is configured to store the changes in the previous version of the block management table, wherein the current version of the block management table is used in conjunction with the table 330 and/or the table 320 to reconstruct the block management table of the DRAM 162 upon power interruption,

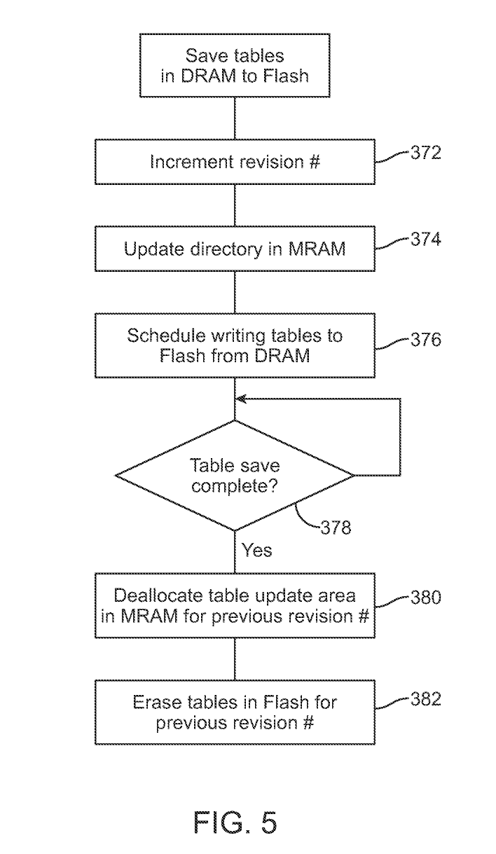

FIG. 5 shows a process flow of the relevant steps performed in allocating tables using the embodiments shown and discussed above and in accordance with a method of the invention. The steps of FIG. 5 are generally performed by the CPU of the CPU subsystem 170 of FIG. 1. In FIG. 5, at step 372, the revision number is incremented. Next, at step 347, the directory 310 that resides in the MRAM 140 is updated. Next, at step 376, the copying of tables 340 from the DRAM 162 to the flash 110 is scheduled and started. Next, at step 378, a determination is made of whether or not the copying of step 376 to flash is completed and if not, time is allowed for the completion of copying, otherwise, the process continues to step 380.

Step 378 is performed by “polling”, known to those in the art, alternatively, rather than polling, an interrupt routine is used in response to completion of flash write fall within scope of invention.

All updates to tables 340 is saved in the MRAM (140 or 150) and specifically, in the update 330 therein.

When copy is completed at 378, the latest copy in the flash 110, along with updates to tables in MRAM with current revision number 330 can advantageously completely reconstruct the tables 340 in the event of a power fail. At step 380, the area 320 in the MRAM 140 allocated to updates of previous revision number is de-allocated and can be used. At step 382, the table for the previous revision number 362 in the flash 110 is erased.

In some embodiments in step 374 an invalid revision number is written in the MRAM directory and after step 378 the revision number is written to the MRAM directory. In some such embodiments the step 374 is performed between steps 378 and 380 rather than after the step 372. In yet other such embodiments the step 374 is split up and performed partially after step 372 and partially after step 378 because after the step 372 the information in the MRAM directory is not considered valid yet, after step 378, the information in the MRAM directory is deemed valid.

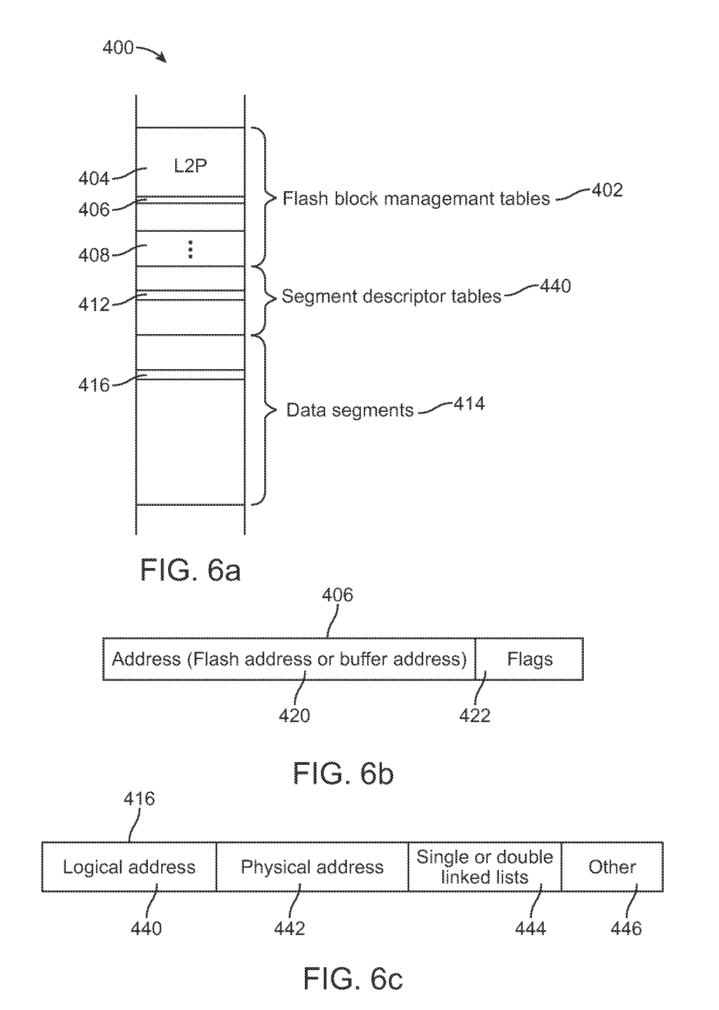

FIGS. 6a-6c show exemplary data structures in the MRAM 150, in accordance with embodiments of the invention supporting cache.

The data area in the MRAM 150 is typically segmented into a plurality of fixed size data segments, where a page is a multiple of data segment size. Associated with each data segment is a descriptor and organized in a table. FIG. 6a shows the data structures 400 in MRAM 150 for a device supporting cache, such as the device 10. The data structures include flash management tables 402, data segment descriptor table 410, and data segments 414.

The flash management tables 402 includes L2P table 404 and other tables 408. The L2P table 404 comprising of L2P descriptors 406. The L2P descriptor 406 includes an address field 420 and a flag field 422, as shown in FIG. 6b. The flags field includes a plurality of flags. A flag in the flag field indicates if a data segment is allocated in MRAM. The address is either a flash address or a address of the segment in the MRAM 150. If the flag is a flash address it indicates that the segment is successfully written to the flash. Alternatively, data segments table updates can be of MRAM and tables in DRAM.

A data segment can be used for different operations and associated states. The operations and states include:
host write data (the segment may be scheduled for receiving host write data or completed the transfer and contain the write data. A host write transfer scheduled and a host write complete flag indicates the state). A host write list is the list of data segments assigned to host write
host read data (the segment may be scheduled for sending read data to host or completed the transfer. A host read transfer scheduled and a host read complete flag indicates the state). A host read list is the list of data segments assigned to host read
flash write data (the segment may be scheduled for sending write data to flash or completed the transfer. A flash write transfer scheduled and a flash write complete flag indicates the state). A flash write list is the list of data segments assigned to flash write
flash read data (the segment may be scheduled for receiving read data from flash or completed the transfer. A flash read transfer scheduled and a flash read complete flag indicates the state). A flash read list is the list of data segments assigned to flash read
Idle (contains valid write data). Idle segments contain valid data which is the same as in flash. An idle segment list is list of idle data segments. Idle segments are not assigned
Free (Not used, and can be allocated). A free segment list is the list of free data segments

A data segment may belong to more than one list for example a host write and a flash write or a flash read and a host read.

The host write and idle lists can doubly function as a cache. After data segment in host write list is written to flash it is moved to idle list. The data segments in host write list and idle list comprise the write cache. Similarly after data segment in host read list is transferred to host it can be moved to a read Idle list. The read idle list is the read cache

Certain logical address ranges can be permanently in the cache, such as all or portion of the file system.

The data segment descriptor table 410 is a table of descriptors for each data segment 416 in data segments 414 of MRAM. The segment descriptor 416, as shown in FIG. 6c, includes a Logical Address 440, a Physical Address 442, a plurality of single linked list pointers or double linked list pointers 444.

FIG. 6b shows further details of the L2P descriptor 406 and FIG. 6c shows further details of the segment descriptor 416.

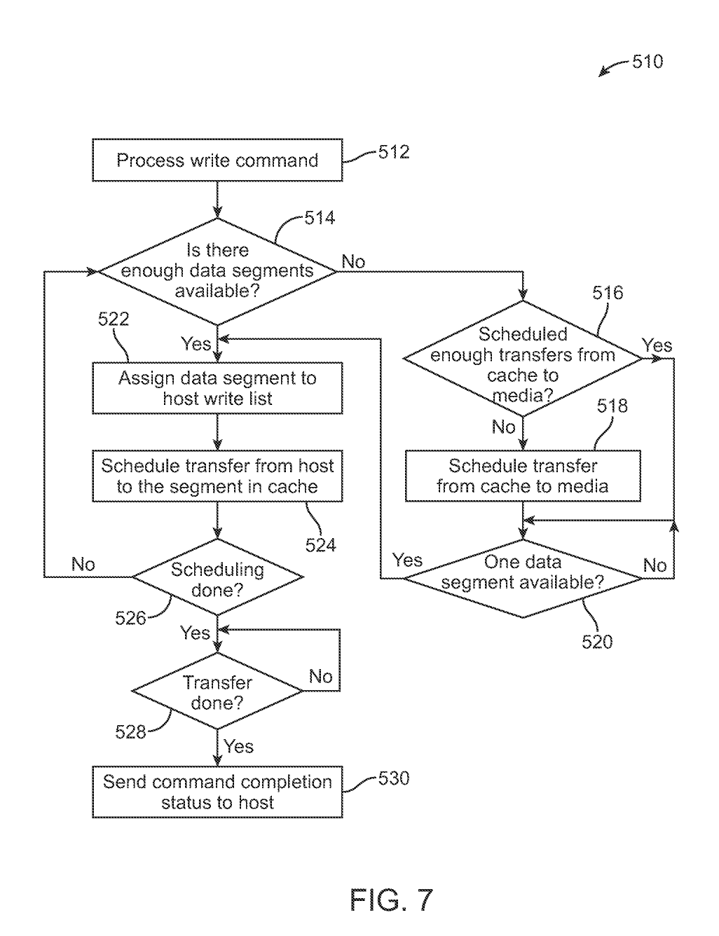

FIG. 7 shows a process flow 510 of the relevant steps performed when writing data to the cache in the MRAM 150 of the system 10, in accordance with a method of the invention. The steps of FIG. 7 are generally performed by the device 10. At 514, a determination is made of whether or not there is sufficient data segments available in MRAM 150 and if so, the process continues to step 522, otherwise, the process continues to 516 where another determination is made. The determination of 516 is of whether or not sufficient transfer from cache to the media has been scheduled. The media is the flash 110 in FIG. 1 and cache is the MRAM 150 in FIG. 1.

If at 516, it is determined sufficient number of transfers has not been scheduled, the process continues to step 518 where additional transfer of data from the cache to the media is scheduled, otherwise, the process continues to 520 where it is determined whether or not a free data segment is available and if so, the process goes to step 522, otherwise, the process continues back up to 520 and waits until a free data segment becomes available. If at 516, it is determined that sufficient transfers from cache to the media is scheduled, the process continues to step 520.

At step 522, data segments are assigned to the host write list and the process then continues to the step 524 where transfer from the host 101 scheduled to the segment in the cache and the process continues to 526.

At 526, it is determined whether or not scheduling is done and if so, the process continues to 528, otherwise, the process goes to 514. At 528, it is determined whether or not the transfer is done and if so, the process continues to step 530 where a command completion status is sent to the host 101, otherwise, the process goes back to 528 awaiting completion of the transfer of data from the host 101 to the cache.

In summary, in FIG. 7, at step 514, the data segment availability is checked. If a data segment is available in MRAM the process moves to step 522 and assigns a data segment to write cache, and proceeds to step 524. At step 524 the transfer from the host 101 over the host bus 103 to the available data segments are scheduled, and proceeds to step 526 to check scheduling transfers is completed. If scheduling transfers associated with command is not complete then go repeat step 514, else proceed to step 528 and check if all scheduled transfers are complete. If data transfer is complete proceed to step 530 and at step 530 send command completion status to host 101 over host bus 103. At step 514 if there is not enough data segments available then the process proceeds to step 516. At step 516 if sufficient transfers from write cache to flash is scheduled proceed to step 520 else move to step 518 and schedule additional transfers from write cache to flash, and then proceed to step 520 to check if at least one data segment is available. At step 520. If one data segment is available then proceed to step 522.

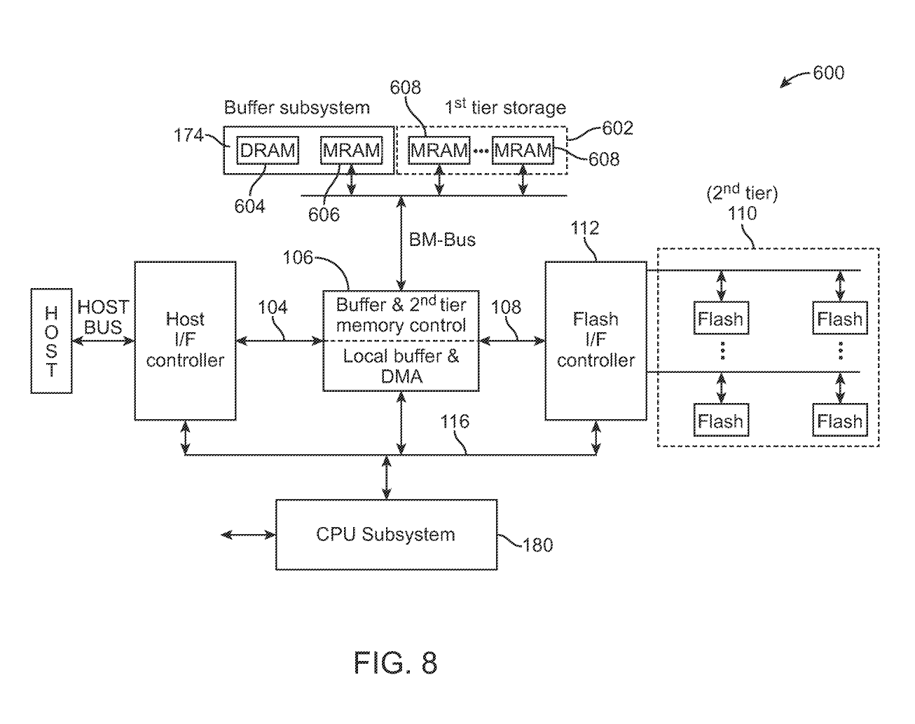

FIG. 8 shows a SSD 600 in accordance with another embodiment of the invention. The device 600 is analogous to that of FIG. 1 except that a different buffer subsystem is shown in the embodiment of FIG. 8 as opposed to that of FIG. 1. The buffer subsystem 174 of FIG. 8 is shown to include a DRAM 604 and a MRAM 606 coupled to the buffer memory block 106 through the BM-Bus. The DRAM 604 is analogous to the DRAM 162 and the MRAM 606 is analogous to the MRAM 150. Also shown coupled to the BM-Bus is a first tier storage device 602 including a number of MRAM devices 608.

The embodiment of FIG. 8 shows a two tier storage made of MRAM and flash. The first tier storage, first tier storage device 602, is based on MRAM that resides on BM-Bus along with buffer subsystem. As previously discussed, BM-Bus may be a single bus or alternatively, it may be made of multiple busses. The second tier is based on flash comprising of flash 110. In this embodiment most recently and most frequently accessed data (hot data) reside in first tier and less frequently accessed data reside in flash via the use of the filter software driver either installed on the host's OS or integrated in the OS. The filter software driver monitors the incoming data traffic and determines where data should be stored. Determination of hot data is dynamic and causes some additional transfer between the first and the second tier storage as the frequency and recency of data access changes.

System management information for maintaining the SSD includes flash block management. Other system management information includes transaction log. A transaction log includes a record of write operation to flash (dynamically-grouped) pages or (dynamically-grouped) blocks and its status, start and completion and optionally progress. The start status indicates if operation was started. The completion status indicates if operation was completed, and if the operation is not completed the error recovery initiated. Maintaining transaction logs in flash or volatile memory suffers from same problems discussed earlier. Embodiments of the invention apply to all system management information and not limited to flash block management tables.

Although the embodiment is described for the case that the previous revisions in flash and previous updates in MRAM are kept until the current copy to flash is completed we can keep one or more of the previous updates in flash and MRAM. For example If n indicates current revision number we would keep n−1 and n−2 once writing n to flash is completed we deallocate update associated with n−2 and erase tables associated with n−2 in flash

Although using the embodiment of caching write data for write commands (or queued write commands when command queuing is supported) and issuing command completion prior to writing to media was described for solid state disk drive it is obvious to one skilled in the art to apply to HDD. Replacing flash I/F controller with HDD controller and replacing flash with hard disk

Although the invention has been described in terms of specific embodiments using MRAM, it is anticipated that alterations and modifications thereof using similar persistent memory will no doubt become apparent to those skilled in the art. It is therefore intended that the following claims be interpreted as covering all such alterations and modification as fall within the true spirit and scope of the invention.

Although the invention has been described in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

What is claimed is:

1. A solid state storage device (SSD) configured to store information from a host, in blocks, the solid state storage device comprising:
a buffer subsystem including dynamic random access memory (DRAM), the DRAM including one or more block management tables that maintain information used to manage blocks in solid state storage device, the one or more block management tables including tables used to map logical to physical blocks for identifying the location of stored data in the SSD, the DRAM used to save versions of at least some of the one or more block management tables;
a flash subsystem including flash memory, the flash memory configured to save snapshots of the one or more block management table including a previous version of the one or more block management tables and a current version of the one or more block management tables,
the SSD including a magnetic random access memory (MRAM), the MRAM configured to store changes to the one or more block management tables in the DRAM,
wherein the current version of the snapshot of the one or more block management tables is used to reconstruct the one or more block management tables of the DRAM upon power interruption to the solid state storage device.

2. The solid state storage device, as recited in claim 1, wherein the MRAM includes a first MRAM table and a second MRAM table, the first MRAM table configured to store the changes in the current version and the second MRAM table configured to store the changes in the previous version, wherein the current version is used in conjunction with the first MRAM table and/or the second MRAM table to reconstruct the one or more block management tables of the DRAM upon power interruption.

3. The solid state storage device, as recited in claim 1, further including a CPU subsystem wherein the CPU subsystem includes an MRAM.

4. The solid state storage device, as recited in claim 1, wherein the buffer subsystem includes an MRAM.

5. The solid state storage device, as recited in claim 1, wherein the MRAM is made of STTMRAM.

6. A method of block management in a solid state storage device comprising:
saving block management tables in a dynamic random access memory (DRAM) to a flash subsystem, the flash subsystem including flash memory;
incrementing a revision number;
scheduling writing tables to the flash subsystem from the DRAM, the tables in the flash subsystem including a previous revision table; and
upon completion of saving the block management tables, updating a directory in a magnetic memory access memory (MRAM) to reflect the incrementing of the revision number, the MRAM including a previous revision table;
dellocating the previous revision table in the MRAM; and
erasing the previous revision table.

7. A method of managing blocks in a solid state storage device comprising:
a buffer subsystem responsive to data from a host that is coupled to the host, the data in the buffer subsystem being identified by an address and to be transferred to a media, the media being made of flash memory, the flash memory configured to store the data using an address to identify the location of the data in the media;
upon the host reading from the solid state storage device before the data is transferred to the buffer subsystem from the media, accessing a flag indicative of whether the location of the data is in the buffer subsystem or the media; and
based on the state of the flag, the host data being read from the buffer subsystem or the media.

8. A method of block management in a solid state storage device comprising:
a. receiving a write command from a host;
b. determining whether or not enough data segments are available for storage of data;
c. upon determining enough data segments are available, assigning data segments and scheduling transfers from the host to the buffer subsystem for the write command;
d. upon determining enough data segments are not available, performing:
i. scheduling an adequate number of data transfers from a buffer subsystem to a media;
ii. assigning data segments and scheduling data transfer from the host to the buffer subsystem as data segments become available, until all scheduling of transfers from host to the buffer subsystem is completed for the write command.

9. A solid state storage device (SSD) configured to store information from a host, in blocks, the solid state storage device comprising:
a buffer subsystem including dynamic random access memory (DRAM) and a magnetic random access memory (MRAM), the DRAM including one or more block management tables that maintain information used to manage blocks in solid state storage device, the one or more block management tables including tables used to map logical to physical blocks for identifying the location of stored data in the SSD, the DRAM used to save versions of at least some of the one or more block management tables, the MRAM configured to store changes to the one or more block management tables in the DRAM;
flash subsystem including flash memory, the flash memory configured to save snapshots of the one or more block management table including a previous version of the one or more block management tables and a current version of the one or more block management tables;
a first tier storage device including at least one MRAM devices,
the flash subsystem including a second tier made of flash,
wherein the current version of the snapshot of the one or more block management tables is used to reconstruct the one or more block management tables of the DRAM upon power interruption to the solid state storage device.

10. The SSD of claim 9, wherein the first tier storage device stores most recently and most frequently accessed data that is stored in the flash memory and the second tier stores less frequently accessed data that is stored in the flash memory.

11. The SSD of claim 9, wherein data is transferred between the first and the second tier based on the frequency and recency of the data.

12. The SSD of claim 9, wherein the MRAM is made of STTMRAM.

13. The SSD of claim 9, further including a CPU subsystem, wherein the CPU subsystem includes an MRAM.

14. The SSD of claim 8, wherein the buffer subsystem includes an MRAM.
